(19) United States
(12) Patent Application Publication
(10) Pub. No.: US 2007/0027648 A1
(43) Pub. Date: Feb. 1, 2007

(54) Clinical testing information processing apparatus, clinical testing information processing method, and analyzing system

(75) Inventor: Norio Kowata, Kobe-shi (JP)

Correspondence Address: BRINKS HOFER GILSON & LIONE, P.O. BOX 10395, CHICAGO, IL, 60610, US

(73) Assignee: Sysmex Corporation

(21) Appl. No.: 11/479,016

(22) Filed: Jun. 30, 2006

(30) Foreign Application Priority Data
Jul. 5, 2005 (JP) 2005-196072

(51) Int. Cl. G06F 19/00

(52) U.S. Cl. 702/84

(57) ABSTRACT

A clinical testing information processing apparatus is provided in which testing results having a low reliability are prevented with certainty from being reported to a physician. A clinical testing information processing apparatus for processing analysis results showing results of analyzing specimens includes obtaining means for obtaining quality control result information showing a result of quality control of an analyzing apparatus for analyzing specimens and specimen validation means for validating an analysis result when the analyzing apparatus has analyzed a specimen, on the basis of the quality control result information obtained by the obtaining means.

This application claims priority under 35 U.S.C. §119 to Japanese Patent Application No. 2005-196072 filed Jul. 5, 2005, the entire content of which is hereby incorporated by reference.

### FIELD OF THE INVENTION

The present invention relates to a clinical testing information processing apparatus, a clinical testing information processing method, and an analyzing system.

### BACKGROUND OF THE INVENTION

From the past, in testing a specimen such as blood or urine of a patient, a testing result obtained by an analyzing apparatus is confirmed by a testing engineer and, when the aforesaid testing result satisfies a predetermined condition, the testing result is validated and reported to a physician.

As a clinical testing system that can perform such validation of testing results, a clinical testing system disclosed in Japanese Laid-Open Patent Publication No. 2001-155093 is known, for example. According to this clinical testing system, a flag is input and attached to a testing result that has finished validation by a testing engineer, and a physician can make reference only to the testing results to which the flag has been input and attached. Therefore, the physician can be prevented from making reference to non-validated testing results.

On the other hand, in order to measure a patient specimen correctly with the aforesaid analyzing apparatus, the analyzing apparatus must be used in a state in which the performance according to the specification defined by the manufacturer is exhibited. For this reason, quality control is generally carried out in which a quality control material prepared to give a predetermined measurement result is measured and, when the measurement result goes out beyond a predetermined range (normal range) from the target value, it is determined that some sort of abnormality is occurring to the analyzing apparatus. When the measurement result of the quality control material is out of the normal range, the measurement result cannot be reported to a physician, because the results obtained by analyzing a specimen of a patient with use of such an analyzing apparatus have a low reliability.

However, in a conventional clinical testing system, the quality control data of an analyzing apparatus and the measurement results of patient specimens are separately controlled. Moreover, there are many cases in which a plurality of testing engineers are involved in the system other than the person that has conducted the quality control. Therefore, in order to perform quality control with certainty and to report only the measurement results having a high reliability to a physician, a lot of cumbersome confirmation work has been required.

Also, U.S. Pat. No. 6,269,276 discloses a multi-rule quality control testing apparatus that displays a result of quality control together with an analysis result on a screen that displays the analysis result. With this apparatus, when the analysis result is a patient result, technical validation is carried out, and thereafter the QC test status validation is carried out.

### SUMMARY OF THE INVENTION

The scope of the present invention is defined solely by the appended claims, and is not affected to any degree by the statements within this summary.

The first aspect of the present invention relates to a clinical testing information processing apparatus for processing analysis results showing results of analyzing specimens, comprising:
an obtaining section for obtaining quality control result information showing a result of quality control of an analyzing apparatus for analyzing specimens; and
a specimen validating section for validating an analysis result when said analyzing apparatus has analyzed a specimen, on the basis of the obtained quality control result information.

The second aspect of the present invention relates to a clinical testing information processing apparatus comprising:
an obtaining section for obtaining an analysis result showing a result of analysis of a specimen and quality control result information showing a result of quality control of an analyzing apparatus that analyzes the specimen;
a displaying section for displaying the analysis result and the quality control result information obtained by the obtaining section; and
a validation accepting section for accepting a command of validation of said analysis result,
wherein information related to validation of said quality control result is displayed on a screen for validating said analysis result.

The third aspect of the present invention relates to a clinical testing information processing method comprising the steps of:
obtaining quality control result information showing a result of quality control of an analyzing apparatus for analyzing specimens; and
validating an analysis result when said analyzing apparatus has analyzed a specimen, on the basis of the obtained quality control result information.

The fourth aspect of the present invention relates to an analyzing system comprising:
an analyzing section for analyzing specimens;
an obtaining section for obtaining quality control result information showing a result of quality control of the analyzing section; and
a specimen validating section for validating an analysis result when said analyzing section has analyzed a specimen, on the basis of the obtained quality control result information.

### BRIEF DESCRIPTION OF THE DRAWINGS

FIG. 1 is a view illustrating a construction of one embodiment of a clinical testing information processing system according to the present invention;

FIG. 2 is a block diagram showing a construction of a server computer in the system shown in FIG. 1;

FIG. 3 is a view for describing the contents of a hard disk in the server computer shown in FIG. 2;

FIG. 4 is a flowchart showing procedures of a process executed by a communication program that is installed in the server computer shown in FIG. 2;

FIG. 5 is a flowchart showing procedures of a process executed by a quality control result manual validation program that is installed in the server computer shown in FIG. 2;

FIG. 6 is a flowchart showing procedures of a process executed by a patient specimen result manual validation program 1 that is installed in the server computer shown in FIG. 2;

FIG. 7 is a flowchart showing procedures of a process executed by a reporting program that is installed in the server computer shown in FIG. 2;

FIG. 8 is a view illustrating one example of a quality control result validation screen that is displayed by a client computer in the system shown in FIG. 1;

FIG. 9 is a view illustrating another example of a quality control result validation screen that is displayed by a client computer in the system shown in FIG. 1;

FIG. 10 is a view illustrating one example of a patient specimen result validation screen that is displayed by a client computer in the system shown in FIG. 1;

FIG. 11 is a view illustrating another example of a patient specimen result validation screen that is displayed by a client computer in the system shown in FIG. 1;

FIG. 12 is a flowchart showing procedures of a process executed by a patient specimen result manual validation program 2 that is installed in the server computer shown in FIG. 2;

FIG. 13 is a flowchart showing procedures of a process executed by a patient specimen result automatic validation program 1 that is installed in the server computer shown in FIG. 2;

FIG. 14 is a flowchart showing procedures of a process executed by a patient specimen result automatic validation program 2 that is installed in the server computer shown in FIG. 2;

FIG. 15 is a view illustrating a construction of another embodiment of a clinical testing information processing system according to the present invention;

FIG. 16 is a block diagram showing a construction of a computer of an analyzing apparatus in the system shown in FIG. 15; and

FIG. 17 is a view for describing the contents of a hard disk in the computer shown in FIG. 16.

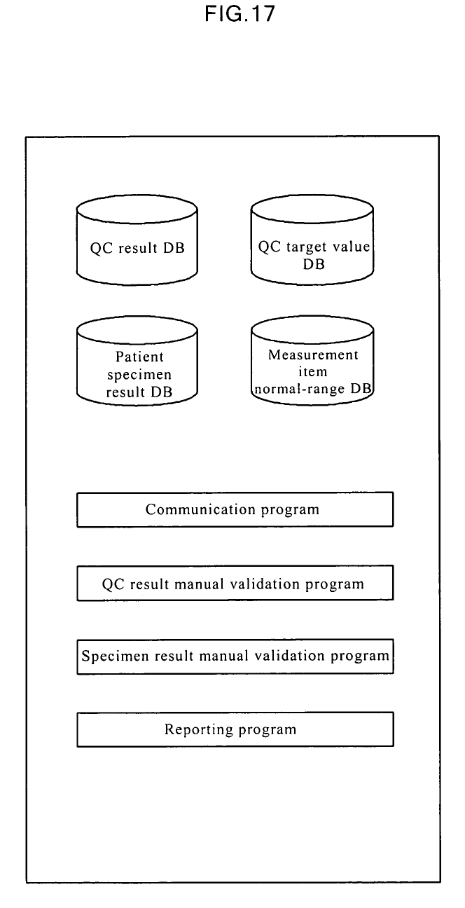

### DETAILED DESCRIPTION OF THE EMBODIMENTS

Hereafter, embodiments of the present invention will be described with reference to the attached drawings.

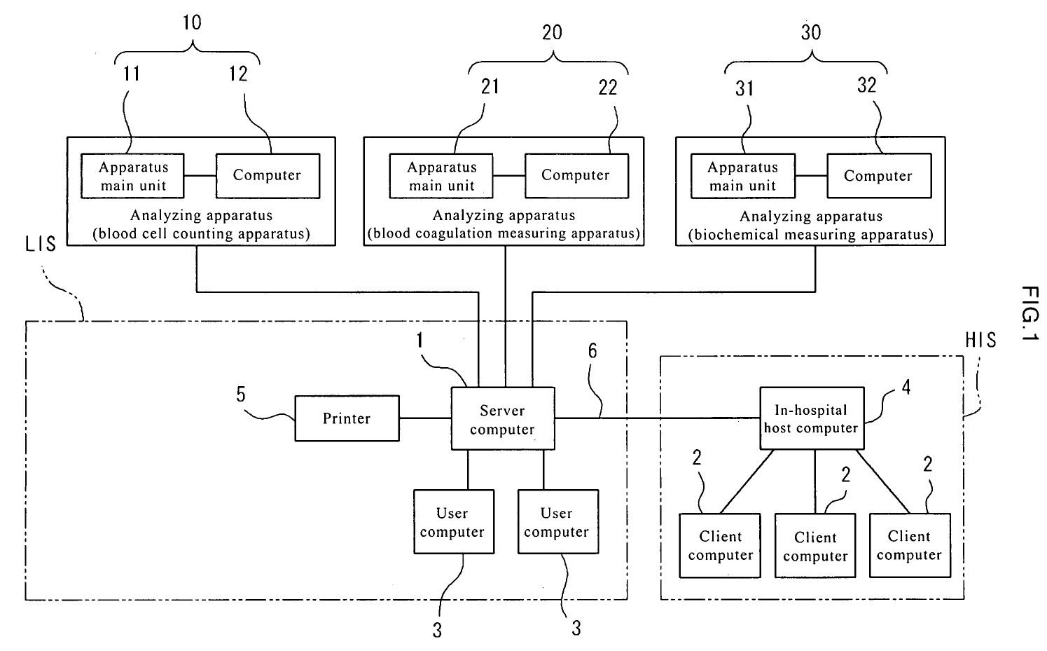

FIG. 1 is a view illustrating a construction of one embodiment of a clinical testing information processing system (which may hereafter be simply referred to also as “system”) according to the present invention. The system according to this embodiment is mainly constructed with analyzing apparatus 10, 20, 30 that analyze specimens such as blood and urine of a patient and are capable of outputting analysis results showing the results thereof to outside, a server computer 1 which is a clinical testing information processing apparatus that receives and processes the analysis results, and user computers 3 that are connected to the server computer 1 and on which a testing engineer performs operation such as validation of the analysis results. In this embodiment, three client computers 2 that serve as terminals for making reference to the analysis results are provided in a hospital, and these client computers 2 are connected to the server computer 1 via an in-hospital host computer 4. Also, to the server computer 1, a printer 5 is connected that constitutes outputting means for outputting the analysis results and others of patient specimens. An LIS (Laboratory Information System) is constructed with the server computer 1, the user computers 3, and the printer 5. An HIS (Hospital Information System) is constructed with the in-hospital host computer 4 and the client computers 2. A network such as LAN is present for connection between the server computer 1 and the in-hospital host computer 4, between the in-hospital host computer 4 and the client computers 2, between the server computer I and the user computers 3, and the like. Here, in the present specification, the testing engineers and others on the side that performs analysis and validation of specimens are referred to as “users”, and physician, nurses, patients, and others on the side that requests testing and makes reference to the obtained testing results for use are referred to as “clients”. Also, in the present specification, “specimens” refer to specimens for analysis that have been supplied from human beings or animals such as patients or subjects of health diagnosis, excluding the cases in which they are referred to as “quality control specimens” or “QC specimens”.

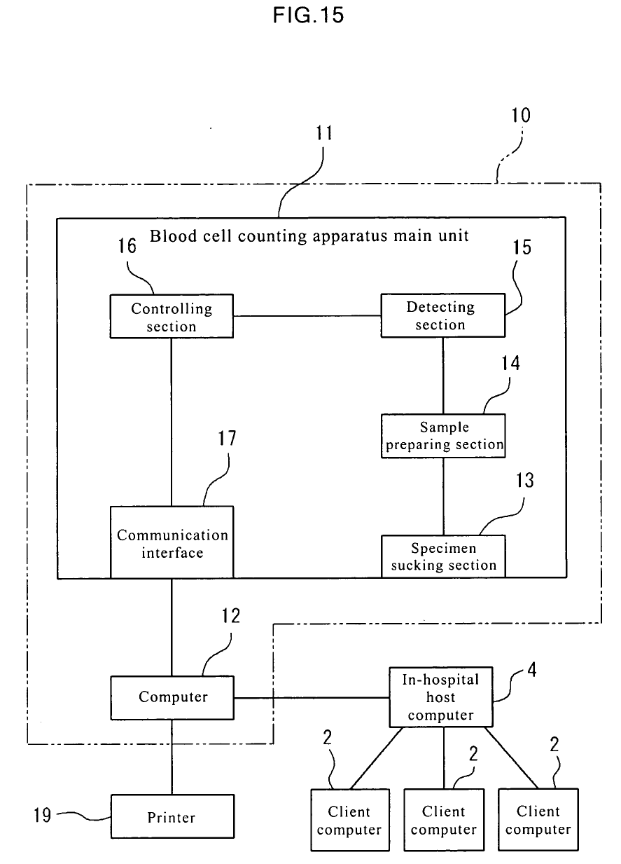

The analyzing apparatus 10 is a blood cell counting apparatus and includes an analyzing apparatus main unit 11 and a computer 12; the analyzing apparatus 20 is a blood coagulation measuring apparatus and includes an analyzing apparatus main unit 21 and a computer 22; and the analyzing apparatus 30 is a biochemical measuring apparatus and includes an analyzing apparatus main unit 31 and a computer 32. The analyzing apparatus main unit 11 includes a general construction of a blood cell counting apparatus of this kind that is made of a specimen sucking section for collecting blood of a patient constituting a specimen into the apparatus, a sample preparing section for preparing a sample for detection (measurement) from the specimen, a detecting section for detecting optical information and/or electrical information from this sample, a communication interface for performing communication with the outside of the apparatus main unit, and a controlling section for controlling operation of the specimen sucking section, the sample preparing section, and the detecting section and for counting the number of blood cells on the basis of the information obtained by the detecting section (See FIG. 15). Also, though not illustrated in the drawings, the analyzing apparatus main unit 21 and the analyzing apparatus main unit 31 each include a general construction in the same manner as the analyzing apparatus main unit 11 described above.

Typically, the user computer 3 is operated by a testing engineer, and the client computer 2 is operated by a physician in charge. However, depending on the kind of information, physicians other than the physician in charge, nurses, or patients themselves may operate the client computer 2 for making reference to the analysis results and the like.

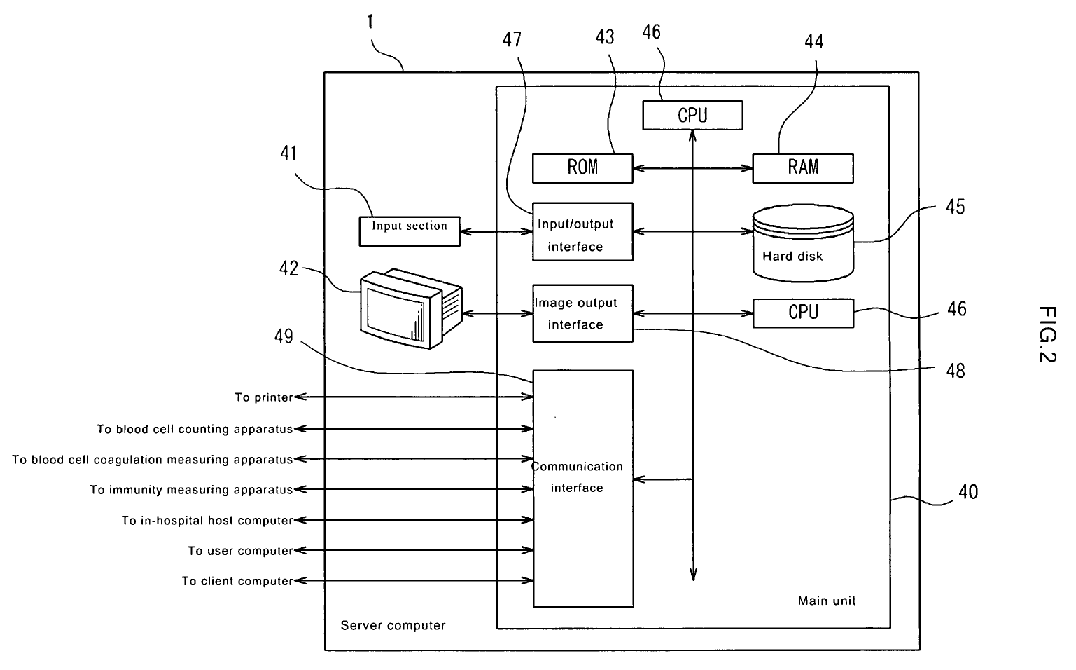

Referring to FIG. 2, the server computer 1 is mainly constructed with a computer main unit 40, an inputting section 41, and a displaying section 42. The computer main unit 40 includes a ROM 43, a RAM 44, and a hard disk 45 serving as storage means, a CPU 46 serving as processing means for performing processes such as calculation and determination, and various interfaces such as an input/output interface 47, an image output interface 48, and a communication interface 49. The server computer 1 described above is adapted to function as obtaining means for obtaining quality control result information showing a result of quality control of an analyzing apparatus that analyzes a specimen, specimen validating means for validating an analysis result when the analyzing apparatus has analyzed a specimen on the basis of the quality control result information obtained by the obtaining means, and validation permitting means for determining whether validation of the analysis result obtained when the analyzing apparatus has analyzed the specimen can be made or not on the basis of the quality control result information obtained by the obtaining means in the present invention.

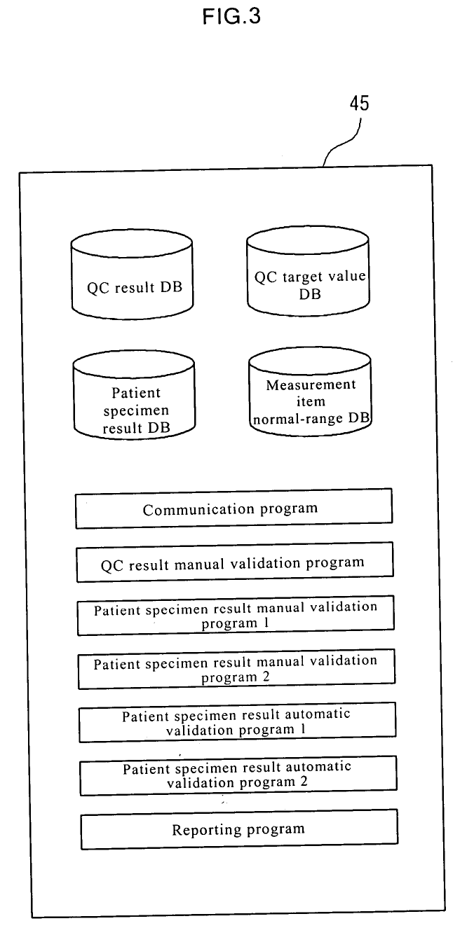

Referring to FIG. 3, the hard disk 45 stores various databases (which may hereafter be referred to also as DB) and programs. Specifically, a QC result DB that stores the result of quality control (which may hereafter be simply referred to as QC also), a patient specimen result DB that stores analysis results of specimens of patients, a QC target value DB that stores target values of the analysis results of specimens for quality control, a measurement item normal-range DB that stores the normal range of each measurement item of patient specimens, a communication program, a QC result manual validation program, a patient specimen result manual validation program 1, a patient specimen result manual validation program 2, a patient specimen result automatic validation program 1, a patient specimen result automatic validation program 2, and a reporting program are stored. These DB and programs will be described in detail later.

In the present embodiment, various programs are prepared so that both the validation of the analysis results and the validation of the quality control results can be carried out either manually or automatically as desired. The switching between manual validation and automatic validation may be carried out either by suitable switching means (not illustrated) provided in the server computer 1 or by operation of the inputting section 41, so that the switching is not particularly limited in the present invention.

Next, a method of processing the clinical testing information in the system according to the present embodiment will be described.

As described above, the present embodiment is constructed in such a manner that both the validation of the analysis results and the validation of the quality control results can be carried out either manually or automatically as desired. Specifically, a desired mode can be selected from among the following four modes.

TABLE 1

| | QC | | |
|---|---|---|---|
| Mode | result | Patient specimen | |
| No. | validation | result validation | Program to be used |
| Mode 1 | Manual | Manual | Patient specimen result manual |
| | | | validation program 1 |
| | | | Patient specimen result manual |
| | | | validation program 1 |
| Mode 2 | Automatic | Manual | Patient specimen result manual |
| | | | validation program 2 |
| Mode 3 | Manual | Automatic | QC result manual validation |
| | | | program |
| | | | Patient specimen result |
| | | | automatic validation program 1 |
| Mode 4 | Automatic | Automatic | Patient specimen result |
| | | | automatic validation program 2 |

[1] Mode 1

In the mode 1, both the QC result validation and the patient specimen result validation are carried out manually. The QC result manual validation program is used for the QC result validation, and the patient specimen result manual validation program 1 is used for the patient specimen result validation.

(1) Data Communication from Analyzing Apparatus

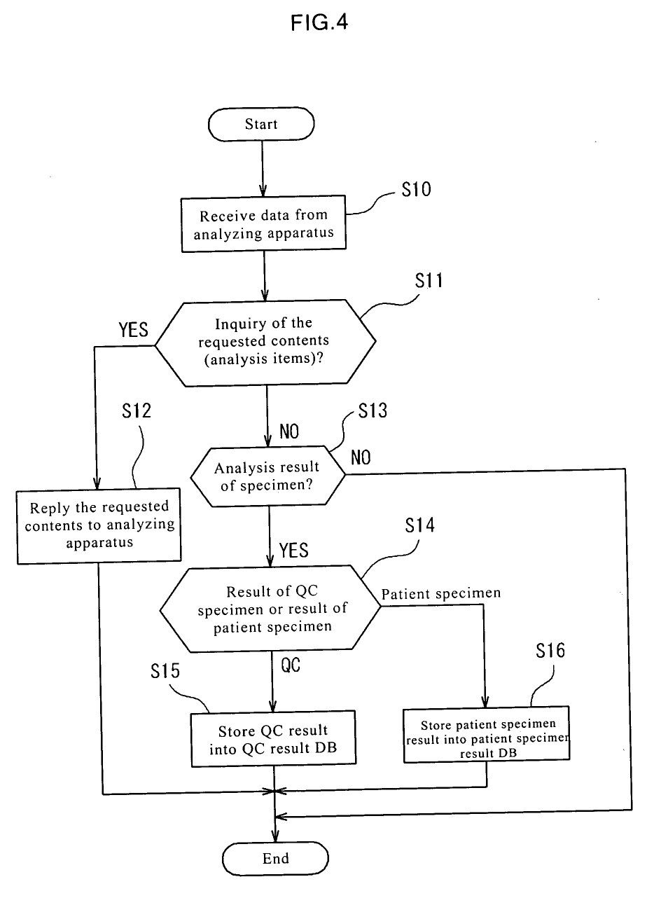

While this is common for all the modes, the analysis results of the analyzing apparatus 10, 20, 30 (including both the patient specimens and the specimens for quality control) are transmitted to the server computer 1, and are stored into predetermined databases of the server computer 1. FIG. 4 is a flowchart showing procedures of a process executed by a communication program that receives these data (which are installed in the server computer 1; this applies also to other later-described programs).

First, when the server computer 1 receives data from the analyzing apparatus 10, 20, 30 (step S10), the server computer 1 determines whether the data are an inquiry of the requested contents (analysis items) or not (step S11). The data transmitted from the analyzing apparatus 10, 20, 30 are typically two kinds including inquiries of the requested contents and analysis results. First, the server computer 1 determines whether or not the data are an inquiry from an analyzing apparatus on what should be analyzed.

If the data are an inquiry of requested contents (analysis items), the server computer 1 replies the requested contents (analysis items) to the analyzing apparatus 10, 20, 30 (step S12) and, if not, the server computer 1 determines whether the data are an analysis result of a specimen or not (step S13). If the data are an analysis result of a specimen, the server computer 1 further determines whether the data are an analysis result of a QC specimen or an analysis result of a patient specimen (step S14). If it is determined that the data are an analysis result of a QC specimen, the data will be stored into the QC result DB (step S15). On the other hand, if it is determined that the data are an analysis result of a patient specimen, the data will be stored into the patient specimen result DB (step S16). Table 2 shows one example of the contents of the QC result DB, and Table 3 shows one example of the contents of the patient specimen result DB. Here, in Table 2, the “QC specimen ID” refers to the identification number of the specimen for QC. In Table 3, the “patient ID” refers to the identification number of the patient. The forms of these databases can be suitably changed in accordance with the kind of the analyzing apparatus, the analysis items, and the like.

TABLE 2

| | | | QC | |
|---|---|---|---|---|
| | QC | Measurement | measurement | Validation |
| Apparatus name | specimen | item | result | flag |
| Blood cell | 12345 | WBC | 5.0 × 10³ | 1 |
| counting | | RBC | 4.5 × 10⁶ | 1 |
| apparatus | | Hgb | 12.0 | 0 |
| Blood cell | 54321 | WBC | 2.0 × 10³ | 0 |
| counting | | RBC | 2.5 × 10⁶ | 0 |
| apparatus | | Hgb | 6.0 | 0 |
| Blood coagulation | 1111 | PT | 12.0 | 0 |
| measuring | | APTT | 31.5 | 0 |
| apparatus | | | | |

TABLE 3

| | | Specimen | |
|---|---|---|---|
| | | measurement | |
| Patient ID | Measurement item | result | Validation level |
| 2222 | WBC | 5.5 × 10³ | 1 |
| | RBC | 4.0 × 10⁶ | 1 |
| | Hgb | 11.5 | 1 |

(2) Validation of QC Result

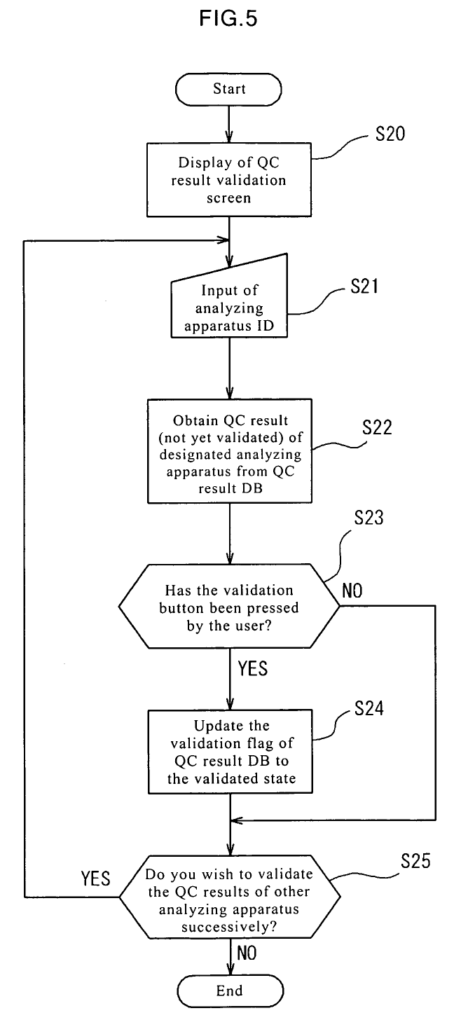

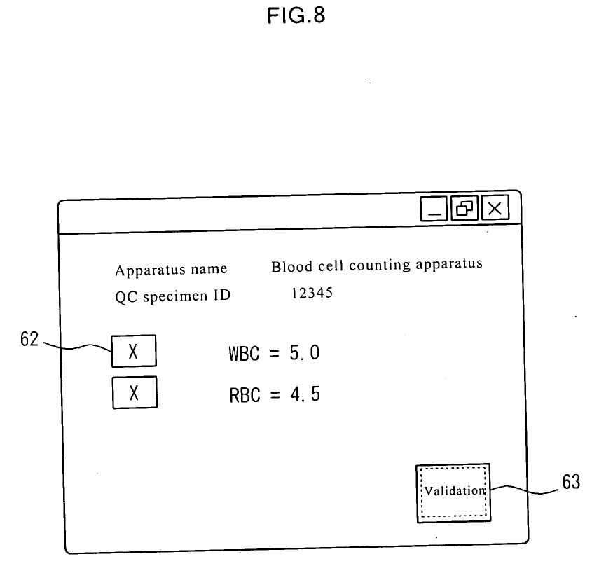

The QC result manual validation program is used for validation of a QC result. FIG. 5 is a flowchart showing procedures of a process executed by the QC result manual validation program such as described above. This program can be set to start, for example, when a testing engineer (user) has opened a screen of his/her own terminal apparatus (user computer 3). When the program is started, first a QC result validation screen is displayed on a displaying section of the terminal apparatus (step S20). When the testing engineer inputs an analysis apparatus ID for specifying an analyzing apparatus on which the QC result is to be validated (step S21), the QC result (not validated yet) of the designated analyzing apparatus will be obtained from the QC result DB (step S22). The testing engineer confirms the QC result that is obtained from the QC result DB and displayed on the QC result validation screen, determines whether or not this is a value that can be validated, and presses a validation button when this is a value that can be validated (step S23). FIG. 8 shows one example of the QC result validation screen such as described above. In FIG. 8, when a “validation” button 63 located on the lower right part of FIG. 8 is pressed by a click, the validation of the QC result is carried out. In the example of FIG. 8, the validation of the QC result is carried out on two items (WBC and RBC), and the symbol “X” is displayed on the check boxes 62 that are to be validated.

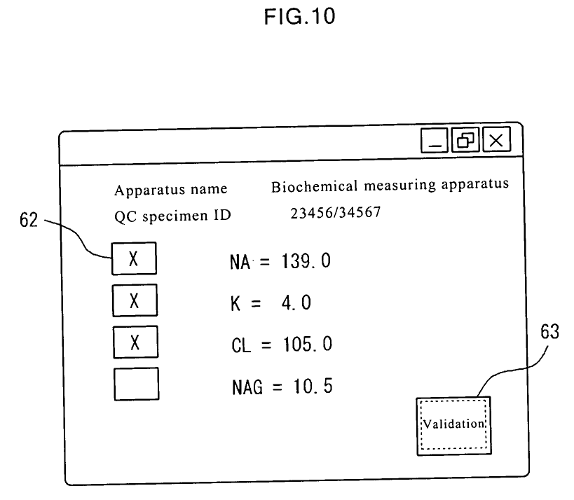

Regarding the validation of the QC specimens, there may be two cases, that is, a case in which all the items that have been measured with regard to one QC specimen are collectively validated and a case in which validation is carried out item by item. For example, in a blood cell counting apparatus that is an object of quality control in the example shown in FIG. 8, it is general that all the measurement items such as WBC and RBC are measured and all the measurement items are collectively reported, so that WBC and RBC are collectively validated. Therefore, in this example, when the QC result validation screen is displayed, the symbol “X” is displayed as a default on the two check boxes. When the “validation” button 63 is pressed by a click, WBC and RBC are collectively validated. On the other hand, in an analyzing apparatus that performs biochemical testing, two kinds of QC specimens are used. One QC specimen may deal with items such as NA (sodium), K (potassium), and CL (chlorine), and the other QC specimen may deal with items such as NAG (acetylglucosaminidase). In this case, the aforesaid four items are displayed simultaneously on the validation screen of the QC result, as shown in FIG. 10. When the result of NAG is far from the target value, the testing engineer validates the QC results of only NA, K, and CL without validating the result of NAG. This individual validation can be carried out, for example, by pressing the “validation” button 63 by a click after designating (pressing by a click) the check boxes 62 of the items that the testing engineer wishes to validate.

When the validation button is pressed, the validation flag of the QC result DB is updated to the validated state (step S24). In the example shown in Table 2, “1” represents the validated state, and “0” represents the non-validated state. When the update of the validation flag of the QC result DB is completed, an inquiry is made on whether the QC results of other analyzing apparatus are to be validated or not (step S25). When the validation is to be carried out successively, the flow returns to the step S22, where the ID of another analyzing apparatus will be input, and the aforesaid procedure will be repeated.

Here, whether the QC result will be validated or not is determined by using as a standard whether or not the QC result is out of a predetermined range (normal range) including the target value of the QC specimen. For example, it can be determined by whether or not the QC result constituting an object of validation is within the range of the target value ±2SD. The aforesaid SD value is calculated each time a QC specimen is analyzed while considering all the results measured on the QC specimens of one and the same lot in an analyzing apparatus on which the quality control is to be carried out. The SD value is obtained by dividing the total sum of the square of the difference between the average value of all the measured values and each of the measured values by the number of the measured data, and taking a square root of the quotient. Here, the standard for validation can be set to be, for example, within a range of the target value +SD, which is a stricter standard, other than within the range of the target value +2SD.

(3) Validation of Patient Specimen Result

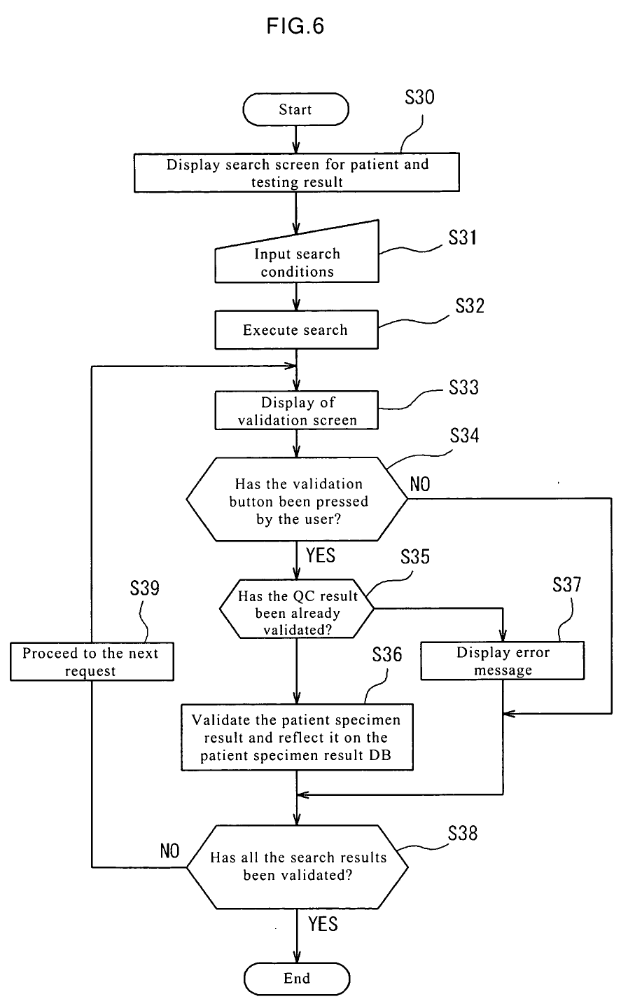

The patient specimen result manual validation program 1 is used for the validation of a patient specimen result. FIG. 6 is a flowchart showing procedures of a process executed by the patient specimen result manual validation program 1 such as described above.

This program can be set to start, for example, at every predetermined period of time, or at predetermined time points (for example, at 10:00 a.m., at 2:00 p.m. and at 4:00 p.m.), or further at every time when a predetermined number of non-validated patient specimen results are accumulated in the patient specimen result DB. When the program is started, a screen for searching a patient and a specimen result will be displayed (step S30). Next, when a search condition is input (step S31), the search is carried out (step S32). The search can be carried out under a suitable condition. For example, the search condition may be the patient ID or the degree of urgency of validation (in this case, the degree of urgency must be set as an attribute of the patient specimen result).

When the search is carried out, a patient specimen result validation screen including the display of the patient ID, the patient specimen result, and the information showing whether the QC result has been validated or not is displayed on the displaying section of the terminal apparatus (user computer 3) of the testing engineer (step S33). When there are plural objects of validation, the validation object screen of the first object will be displayed. At this time, the normal range of the measurement item of the validation object can be displayed on the validation screen. The aforesaid normal range may differ depending on the age, sex, and the like, so that the corresponding one will be extracted from the measurement item normal-range DB stored in the hard disk 45 of the server computer 1 and displayed. Also, other information such as the graph of the past measurement results of the patient can be displayed as well.

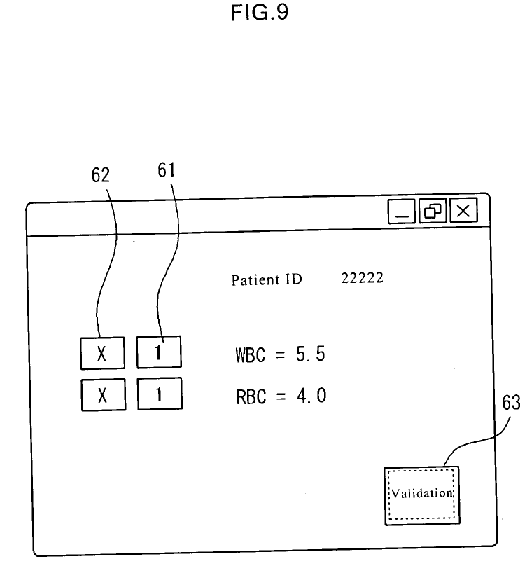

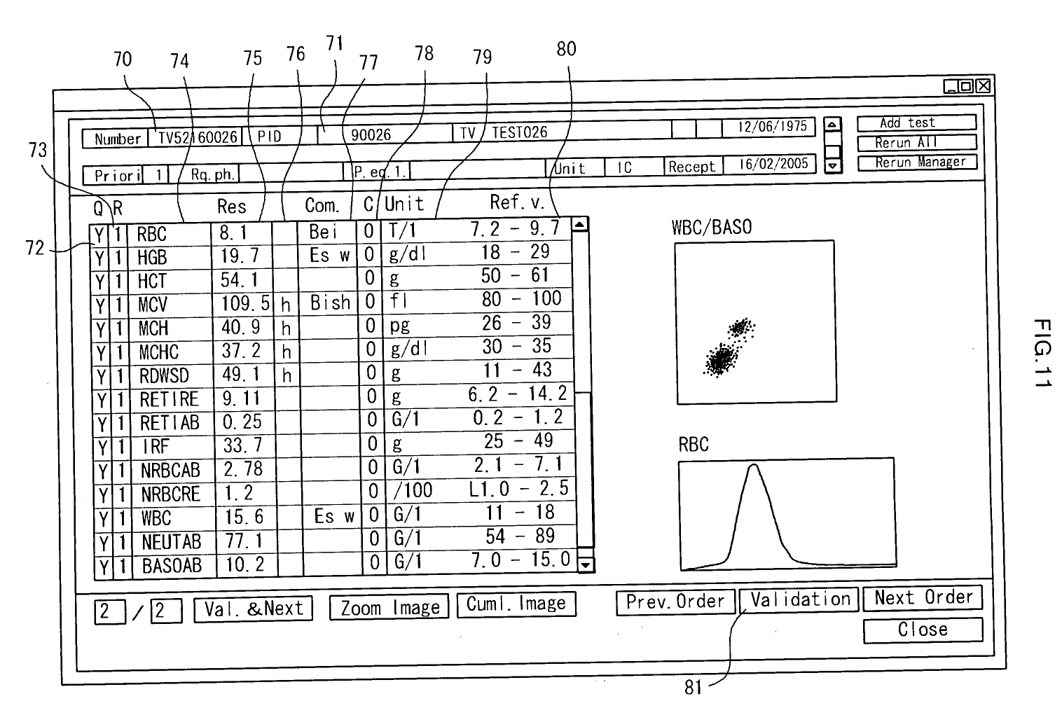

FIG. 9 is a view illustrating one example of a patient specimen result validation screen, and FIG. 11 is a view illustrating another example of a patient specimen result validation screen. The screen shown in FIG. 9 is an example that has been simplified for description, and the screen shown in FIG. 11 is an example in which additional information such as the aforementioned normal range of the measurement item has been added to what it included in FIG. 9 and displayed. In FIG. 9, the check box 61 shows whether the QC result has been validated or not, where “2” represents the validated state, and “1” represents the non-validated state. Also, the check box 62 is a box for carrying out the validation of the patient specimen result, where the symbol “X” represents the validated state, and the blank symbol represents the non-validated state. The validation of the patient specimen result can be carried out by selecting (pressing by a click) the check box of the corresponding measurement item and successively pressing (pressing by a click) the validation button 63.

In FIG. 11, the reference numerals 70 and 71 represent the specimen number and the patient identification number, respectively. On the left side part of the screen, the testing results and others are displayed in a table form. On the right side part of the screen, the image data that are sent from the analyzing apparatus together with the testing results are displayed.

The parts in the table are, sequentially from the left end, a validation circumstance column 72 of the QC results, a validation circumstance column 73 of the patient specimen result, a testing item column 74, a testing result column 75, upper and lower limits mark column 76, a comment column 77 for the testing results, a display column 78 for the re-testing state, a unit column 79, and a standard value column 80. In the validation circumstance column 72 of the QC result, “Y” represents a state of being validated (“N” represents a state of not being validated yet, and the blank represents a state of not being measured yet). In the validation circumstance column 73 of the patient specimen result, “1” represents a state of being measured and not validated yet (“0” represents a state of not being measured yet, and “2” represents a state of being already validated). The upper and lower marks represent the degree by which the testing result goes away from the standard value, and are displayed with one of the symbols “L”, “1”, “h”, and “H”. The symbol “h” shows that the testing result is a little larger than the standard value; “H” shows that the testing result is considerably larger than the standard value; “1” shows that the testing result is a little smaller than the standard value; and “L” shows that the testing result is considerably smaller than the standard value. In this example, the user can validate the patient specimen result by pressing the corresponding measurement item with a click in the validation circumstance column 73 of the patient specimen result and successively pressing the “Validation” button 81 located on the lower right side of the screen with a click.

Here, the screen shown in FIG. 11 is merely one example, so that other items (for example, testing results other than the validation object items of the same patient) can be displayed, and also other display forms can be adopted.

By displaying the information related to the validation of the quality control result in the screen on which the analysis results are to be validated, the testing engineer that wishes to validate the analysis results can validate the analysis results while confirming whether the quality control result of the analyzing apparatus has been validated or not. In other words, the testing engineer can validate the analysis results while grasping the circumstance of the quality control of the analyzing apparatus (whether or not the analyzing apparatus is in a state of being able to perform the functions as stated in the specification of the manufacturer).

The testing engineer confirms the displayed validation circumstance of the QC result, determines whether this can be validated or not, and presses the validation button when this can be validated (step S34).

Subsequently, whether the QC result of the analyzing apparatus by which the aforesaid patient specimen has been analyzed is validated or not is determined (step S35). Specifically, whether the validation flag is “1” or not in the QC result DB is determined. When it is determined that the QC result has been validated, the patient specimen result is validated for the first time, and the result is reflected on the patient specimen result DB (step S36). Specifically, the validation level representing the validation state will be updated to a predetermined value. For example, when three levels of “0” (not measured yet), “1” (not validated yet), and “2” (already validated) are set as this validation level, this validation level can be updated to “2”. Here, even with the same validation, plural levels of validation can be set. For example, when together with a general testing engineer, an upper-level testing engineer who is more experienced and more skilled in testing than this engineer is to validate an analysis result, the validation carried out by the general testing engineer may be set to be validation level 2, and the validation carried out by the upper-level testing engineer may be set to be validation level 3 so that the information regarding the reliability of validation can be supplied to the physicians and others.

On the other hand, when the QC result is not validated yet, an error message will be displayed (step S37). This error message may be, for example, a statement such as “The QC result is not validated yet. Please proceed to validation of the QC result”. By display of the error message, the testing engineer can grasp with ease and with certainty that the quality control result of the analyzing apparatus has not been validated yet, namely, that some kind of trouble has occurred in the analyzing apparatus and that a predetermined quality cannot be expected. By this, the testing engineer can put the analyzing apparatus having a defect found therein to maintenance and repair work at an early time.

Next, whether all the search results have been validated or not is determined (step S38). When the determination is “No”, the flow proceeds to validation of the next request (step S39). When the determination is “Yes”, the patient specimen result validation process is ended.

Here, in the present embodiment, the server computer 1 accepts the validation of the QC results and the patient specimens by allowing the user computer 3 to display the validation screen. However, the validation may be accepted by allowing the validation screen such as described above to be displayed on the displaying section 43.

(4) Reporting of the Patient Specimen Result

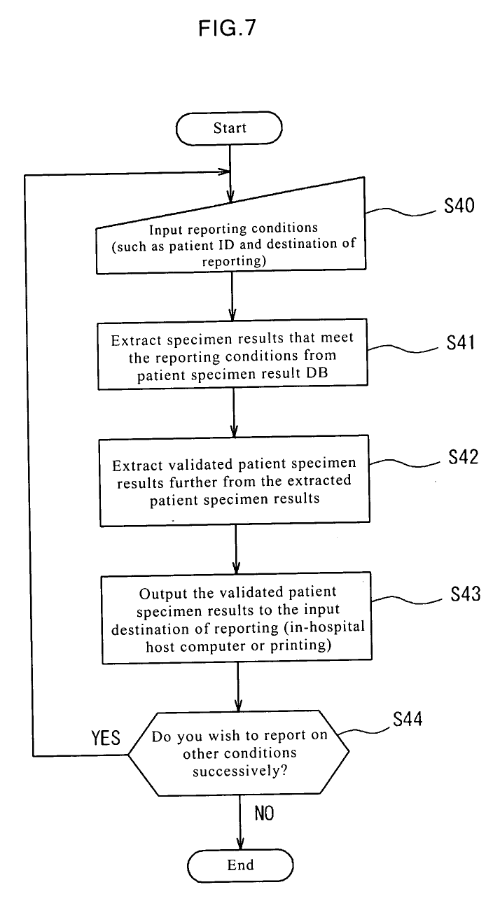

While this is common for all the modes, the validated patient specimen results are reported to the physician in charge and others. FIG. 7 is a flowchart showing procedures of a process executed by a reporting program that reports the patient specimen results such as described above.

This program can be set to start, for example, when the testing engineer has opened a reporting screen or automatically at every predetermined period of time. When the testing engineer inputs reporting conditions such as a patient ID and the destination of reporting (step S40), the patient specimen results that meet the reporting conditions will be extracted from the patient specimen result DB (step S41). Subsequently, only the validated patient specimen results are further extracted from the extracted patient specimen results (step S42). This “validated” state means that both the QC results and the patient specimen results have been validated, as described above.

Then, the extracted validated patient specimen results will be output to the input destination of reporting (in-hospital host computer or printer) (step S43). Subsequently, an inquiry is made on whether successive reporting is to be made on other conditions (step S44). When the answer is “Yes”, the flow returns to the step S40 for input of reporting conditions, whereas when the answer is “No”, the reporting process is ended.

According to the above-described reporting program, only the validated analysis results are output from among the analysis results, so that the user can get only the measurement results that have been obtained from an analyzing apparatus having a high reliability with validated quality control results.

[2] Mode 2

In mode 2, the QC result validation is carried out automatically, and the patient specimen result validation is carried out manually. The patient specimen result manual validation program 2 is used for the patient specimen result validation (The step of automatically validating the QC results is incorporated in the aforementioned patient specimen result manual validation program 2). Here, in the mode 2 and in the modes 3 and 4 described later, the data communication from the analyzing apparatus and the procedure of reporting the patient specimen results are the same as in the mode 1, so that the description thereof will be omitted.

(1) Validation of Patient Specimen Result

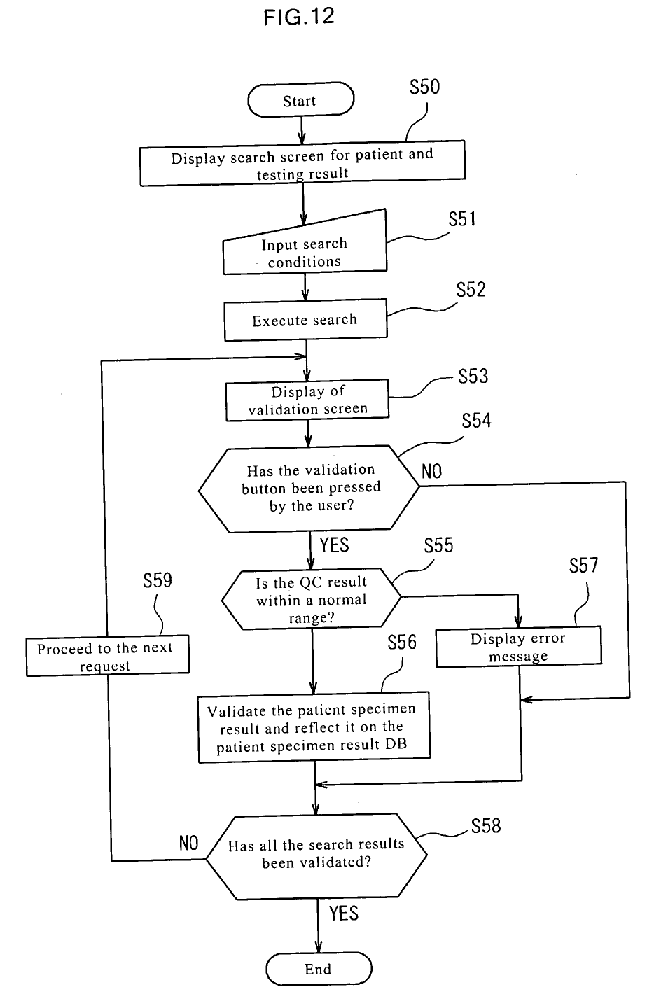

The patient specimen result manual validation program 2 is used for validation of the patient specimen result. FIG. 12 is a flowchart showing procedures of a process executed by a patient specimen result manual validation program 2 such as described above.

When the program is started, a screen for searching a patient and a testing result will be displayed (step S50). Subsequently, when a search condition is input (step S51), the search will be executed (step S52). The search can be carried out under a suitable condition. For example, the search condition may be the patient ID or the degree of urgency of validation (in this case, the degree of urgency must be set as an attribute of the patient specimen result).

When the search is carried out, a patient specimen result validation screen including the display of the patient ID, the patient specimen result, the QC specimen result, and the normal range of the QC specimen result is displayed on the displaying section of the terminal apparatus of the testing engineer (user) (step S53). When there are plural objects of validation, the validation object screen of the first object will be displayed. At this time, the normal range of the measurement item of the validation object can be displayed on the validation screen. The aforesaid normal range may differ depending on the age, sex, and the like, so that the corresponding one will be extracted from the measurement item normal-range DB stored in the hard disk 45 of the server computer 1 and displayed. Also, the graph of the past measurement results of the patient can be displayed as well. The testing engineer confirms the displayed QC specimen result, determines whether this can be validated or not, and presses the validation button when this can be validated (step S54).

Subsequently, whether or not the QC result of the analyzing apparatus by which the patient specimen has been analyzed is within the normal range is determined (step S55). Specifically, whether or not the QC result is within the normal range can be determined according to the above-described determination standard (whether or not the QC result is within the range of the target value ±2SD). Here, this determination standard (whether or not the QC result is within the range of the target value ±2SD) is merely one example, so that other determination standards can be suitably adopted as well.

When the QC result is determined to be within the normal range, the patient specimen result will be validated for the first time, and the result will be reflected on the patient specimen result DB (step S56). Specifically, as described in the mode 1, the validation level representing the validation state will be updated to a predetermined value. On the other hand, when the QC result is not validated, an error message will be displayed (step S57). This error message may be, for example, a statement such as “The QC result cannot be validated. Please check the analyzing apparatus”.

Subsequently, whether all the search results have been validated or not is determined (step S58). When the answer is “No”, the flow proceeds to validation of the next request (step S59). When the answer is “Yes”, the patient specimen result validation process will be ended.

Here, in the above description, after the patient specimen result is validated in the step S54, whether the QC result is within the normal range or not is determined in the step S55. However, the determination of whether the QC result is within the normal range or not may be carried out immediately after the search is carried out (immediately after the step S52).

[3] Mode 3

In the mode 3, the QC result validation is carried out manually, and the patient specimen result validation is carried out automatically. The QC result manual validation program is used for the QC result validation, and the patient specimen result automatic validation program 1 is used for the patient specimen result validation.

Here, the procedure of the QC result validation that is manually carried out is the same as that of the mode 1, so that the description thereof will be omitted.

(1) Validation of Patient Specimen Result

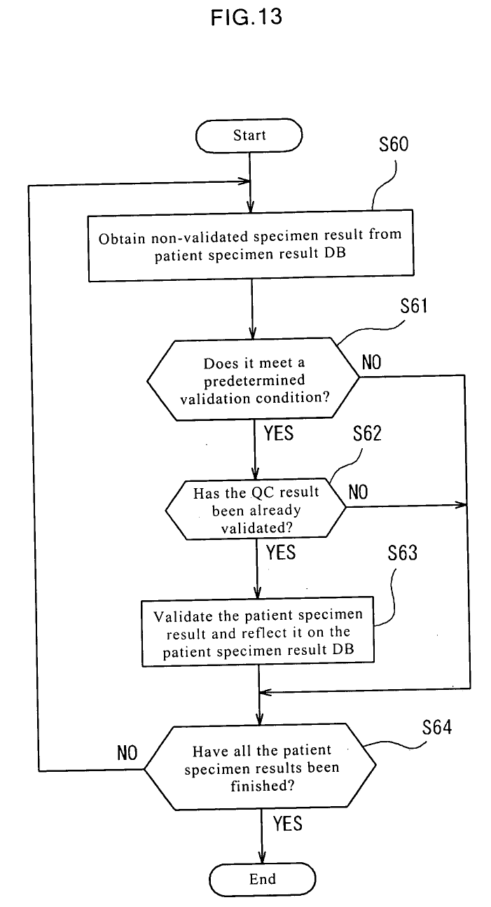

The patient specimen result automatic validation program 1 is used for validation of the patient specimen result. FIG. 13 is a flowchart showing procedures of a process executed by a patient specimen result automatic validation program 1 such as described above.

When the program is started, first a non-validated patient specimen result is obtained from the patient specimen result DB (step S60). Next, whether the obtained patient specimen result meets a predetermined validation condition or not is determined (step S61). Specifically, whether each of the measurement items of the patient specimen result is within a normal range or not is determined while making reference to the measurement item normal-range DB stored in the hard disk 45. When it is determined that all the measurement items are each within the corresponding normal range, the flow proceeds to the next step. Otherwise, the flow proceeds to the step S64 while leaving the corresponding patient specimen result in a state of not being validated yet. The non-validated patient specimen result will be subjected to determination of whether it will eventually be validated or not by the “manual” validation process of the patient specimen result in the above-described mode 1. When the testing engineer determines that, with respect to measurement items that are out of the normal range, the state of being out of the normal range is due to a disease of the patient by judging from the testing results of other measurement items and others, the testing engineer validates the testing result of the patient.

When it is determined that the obtained patient specimen result meets the predetermined validation condition, it is then determined whether the QC result of the analyzing apparatus by which the patient specimen has been analyzed is validated or not (step S62). Specifically, whether the validation flag is “1” or not in the QC result DB is determined. When it is determined that the QC result has been validated, the patient specimen result will be validated, and the result will be reflected on the patient specimen result DB (step S63). Specifically, in the same manner as in the mode 1, the validation level representing the validation state will be updated to a predetermined value. On the other hand, when it is determined in the step S62 that the QC result has not been validated yet, the flow proceeds to the step S64 leaving the patient result in a state of not being validated yet.

Subsequently, whether the validation of all the patient specimen results that meet the reporting conditions have been finished or not is determined. When the answer is “No”, the flow returns to the step S60, where the next non-validated patient specimen result will be obtained from the patient specimen result DB. When the answer is “Yes”, the patient specimen result validation process is ended.

Here, in the above description, whether the QC result has been validated or not is determined in the step S62 after the determination of whether the patient specimen result meets the predetermined validation condition or not is carried out in the step S61. However, these steps may be carried out in a reversed order.

[4] Mode 4

In the mode 4, both the QC result validation and the patient specimen result validation are carried out automatically. The patient specimen result automatic validation program 2 is used for the patient specimen result validation (The step of automatically validating the QC results is incorporated in the aforementioned patient specimen result automatic validation program 2).

(1) Validation of Patient Specimen Result

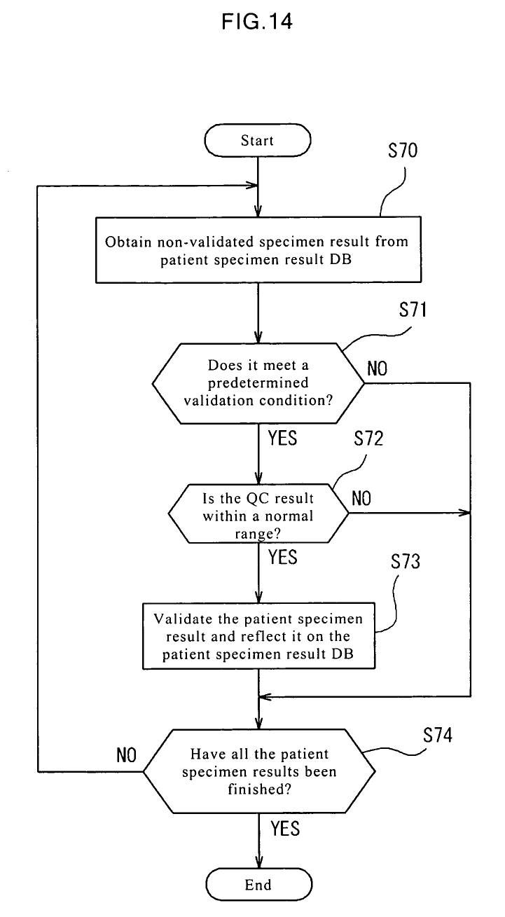

The patient specimen result automatic validation program 2 is used for validation of the patient specimen result. FIG. 14 is a flowchart showing procedures of a process executed by a patient specimen result automatic validation program 2 such as described above.

When the program is started, first a non-validated patient specimen result is obtained from the patient specimen result DB (step S70). Next, whether the obtained patient specimen result meets a predetermined validation condition or not is determined (step S71). Specifically, whether each of the measurement items of the patient specimen result is within a normal range or not is determined while making reference to the measurement item normal-range DB stored in the hard disk 45. When it is determined that all the measurement items are each within the corresponding normal range, the flow proceeds to the next step. Otherwise, the flow proceeds to the step S74 while leaving the corresponding patient specimen result in a state of not being validated yet. The non-validated patient specimen result will be subjected to determination of whether it will eventually be validated or not by the “manual” validation process of the patient specimen result in the above-described mode 1. When the testing engineer determines that, with respect to measurement items that are out of the normal range, the state of being out of the normal range is due to a disease of the patient by judging from the testing results of other measurement items and others, the testing engineer validates the testing result of the patient.

Subsequently, whether or not the QC result of the analyzing apparatus by which the patient specimen has been analyzed is within the normal range is determined (step S72). Specifically, whether or not the QC result is within the normal range can be determined according to the above-described determination standard (whether or not the QC result is within the range of the target value ±2SD). Here, this determination standard (whether or not the QC result is within the range of the target value ±2SD) is merely one example, so that other determination standards can be suitably adopted as well.

When the QC result is determined to be within the normal range, the patient specimen result will be validated, and the result will be reflected on the patient specimen result DB (step S73). Specifically, as described in the mode 1, the validation level representing the validation state will be updated to a predetermined value. On the other hand, when it is determined in the step S72 that the QC result is not within the normal range, the flow proceeds to the step S74 leaving the patient result in a state of not being validated yet.

Subsequently, whether the validation of all the patient specimen results has been finished or not is determined. When the answer is “No”, the flow returns to the step S70, where the next non-validated patient specimen result will be obtained from the patient specimen result DB. When the answer is “Yes”, the patient specimen result validation process is ended.

Here, in the above description, whether the QC result is within the normal range or not is determined in the step S72 after the determination of whether the patient specimen result meets the predetermined validation condition or not is carried out in the step S71. However, these steps may be carried out in a reversed order.

In the mode 4, the analysis results can be automatically validated on the basis of the quality control result information and the analysis results, so that the operation of the testing engineer required in the validation of the analysis results can be simplified.

FIG. 15 is a view illustrating a construction of another embodiment of the system of the present invention. The system according to this embodiment is different from the one shown in FIG. 1 in that the processing means provided with the function of carrying out the validation of the QC results and the patient specimen results is incorporated in the analyzing apparatus. Specifically, the present system is mainly constructed with an analyzing apparatus 10 provided with an analyzing apparatus main unit 11 and a computer 12 and client computers 2 that are connected to the computer 12 and constitute the terminal apparatus capable of making reference to the results analyzed in the analyzing apparatus 10. In the present embodiment, three client computers 2 are disposed, and these client computers 2 are connected to an in-hospital host computer 4. This in-hospital host computer 4 is connected to the computer 12. Also, a printer 19 constituting outputting means for outputting analysis results of patient specimens and others is connected to the computer 12.

The analyzing apparatus 10 is a blood cell counting apparatus, and the analyzing apparatus main unit 11 thereof is made of a specimen sucking section 13 for collecting blood of a patient constituting a specimen into the apparatus, a sample preparing section 14 for preparing a sample for detection (measurement) from the specimen, a detecting section 15 for detecting optical information and/or electrical information from this sample, a communication interface 17 for performing communication with the outside of the apparatus main unit, and a controlling section 16 for controlling operation of the specimen sucking section 13, the sample preparing section 14, and the detecting section 15 and for counting the number of blood cells on the basis of the information obtained by the detecting section 15.

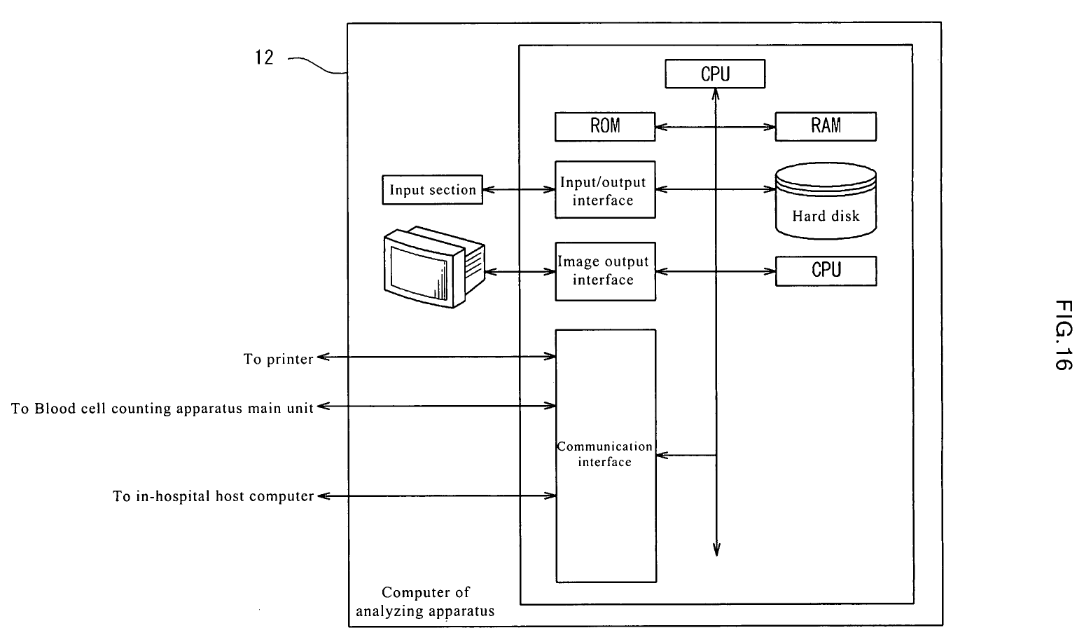

Also, as illustrated in FIG. 16, the computer 12 has the same construction as the server computer 1 shown in FIG. 2 except that the validation programs among the programs stored in the hard disk are only the QC result manual validation program and the patient specimen result manual validation program, and performs the same function as the server computer 1 described above. The QC results and the patient specimen results can be validated in the same manner as in the above-described mode 1. In the present system, the means for processing the analysis results is included in the analyzing apparatus, so that the construction of the system as a whole can be simplified.

Here, in the embodiment shown in FIG. 15 also, the DB and the programs similar to those of the server computer 1 (See FIGS. 2 and 3) can be stored in the hard disk of the computer 12 of the analyzing apparatus 10 as well.

In the above-described clinical testing information processing apparatus, in the system including the same, or in the clinical testing information processing method using these, the analysis results are validated on the basis of the quality control result information that shows the results of quality control of the analyzing apparatus that analyzes the specimens, so that only the measurement results analyzed by an analyzing apparatus that has been validated to be able to exhibit a predetermined quality can be validated. This prevents with certainty an inconvenience such that an analysis result measured by an analyzing apparatus that needs checking and repairing because of not being able to exhibit a predetermined quality is erroneously reported to a physician, and only the analysis results having a high reliability with validated quality control results can be reported to the physician.

Also, in order to process an analysis result showing a result of analyzing a specimen, the aforesaid clinical testing information processing method can be performed by a program that allows a computer to operate as obtaining means for obtaining quality control result information showing a result of quality control of an analyzing apparatus for analyzing specimens, and specimen validating means for validating an analysis result when the analyzing apparatus has analyzed a specimen, on the basis of the quality control result information obtained by the obtaining means.

The foregoing detailed description and accompanying drawings have been provided by way of explanation and illustration, and are not intended to limit the scope of the appended claims. Many variations in the presently preferred embodiments illustrated herein will be obvious to one of ordinary skill in the art, and remain within the scope of the appended claims and their equivalents.

What is claimed is:

1. A clinical testing information processing apparatus for processing analysis results showing results of analyzing specimens, comprising:
an obtaining section for obtaining quality control result information showing a result of quality control of an analyzing apparatus for analyzing specimens; and
a specimen validating section for validating an analysis result when said analyzing apparatus has analyzed a specimen, on the basis of the obtained quality control result information.

2. The clinical testing information processing apparatus according to claim 1, wherein said specimen validating section has a validation permitting section for determining whether validation of the analysis result, which is obtained when said analyzing apparatus has analyzed the specimen, can be made or not on the basis of the obtained quality control result information, and is adapted to validate the analysis result when the validation of the analysis result has been permitted by the validation permitting section.

3. The clinical testing information processing apparatus according to claim 2, further comprising an analysis result validation accepting section for accepting a command of the validation of said analysis result, wherein said specimen validating section is adapted to validate the analysis result when the command of the validation has been accepted by said analysis result validation accepting section and the validation of the analysis result has been permitted by said validation permitting section.

4. The clinical testing information processing apparatus according to claim 3, wherein said validation permitting section determines whether the validation of the analysis result can be made or not when the command of the validation has been accepted by said analysis result validation accepting section.

5. The clinical testing information processing apparatus according to claim 1, further comprising an analysis result validation accepting section for accepting a command of validation of said analysis result, wherein said specimen validating section is adapted to validate the analysis result on the basis of the obtained quality control result information when the command of the validation has been accepted by said analysis result validation accepting section.

6. The clinical testing information processing apparatus according to claim 1, wherein said specimen validating section validates the analysis result on the basis of said quality control result information and the analysis result.

7. The clinical testing information processing apparatus according to claim 1, wherein said quality control result information includes information showing whether the quality control result of the analyzing apparatus has been validated or not, and said specimen validating section is adapted to validate said analysis result when the quality control result of said analyzing apparatus has been validated.

8. The clinical testing information processing apparatus according to claim 1, further comprising a quality control result validation accepting section for accepting a command of the validation of the quality control result of said analyzing apparatus.

9. The clinical testing information processing apparatus according to claim 1, wherein said quality control result information includes information showing whether a result that is obtained when said analyzing apparatus has analyzed a specimen for quality control is within a normal range or not, and said specimen validating section is adapted to validate said analysis result when said result is within the normal range.

10. The clinical testing information processing apparatus according to claim 1, further comprising:
an analysis result storing section for storing said analysis result; and
an outputting section for extracting a validated analysis result from said analysis result storing section and for outputting the extracted analysis result.

11. The clinical testing information processing apparatus according to claim 1, further comprising a validation state storing section for storing a plurality of validation states of said analysis result, wherein said specimen validating section is adapted to validate the analysis result by setting said analysis result to a predetermined validation state.

12. The clinical testing information processing apparatus according to claim 2, further comprising a message outputting section for outputting a message showing denial of the validation when the validation of the analysis result has been denied by said validation permitting section.

13. A clinical testing information processing apparatus comprising:
an obtaining section for obtaining an analysis result showing a result of analysis of a specimen and quality control result information showing a result of quality control of an analyzing apparatus that analyzes the specimen;
a displaying section for displaying the analysis result and the quality control result information obtained by the obtaining section; and
a validation accepting section for accepting a command of validation of said analysis result,
wherein information related to validation of said quality control result is displayed on a screen for validating said analysis result.

14. A clinical testing information processing method comprising the steps of:
obtaining quality control result information showing a result of quality control of an analyzing apparatus for analyzing specimens; and
validating an analysis result when said analyzing apparatus has analyzed a specimen, on the basis of the obtained quality control result information.

15. An analyzing system comprising:
an analyzing section for analyzing specimens;
an obtaining section for obtaining quality control result information showing a result of quality control of the analyzing section; and
a specimen validating section for validating an analysis result when said analyzing section has analyzed a specimen, on the basis of the obtained quality control result information.

16. The analyzing system according to claim 15, further comprising an analysis result validation accepting section for accepting a command of validation of said analysis result, wherein said specimen validating section is adapted to validate the analysis result on the basis of the obtained quality control result information when the command of the validation has been accepted by said analysis result validation accepting section.

17. The analyzing system according to claim 15, wherein said specimen validating section has a validation permitting section for determining whether validation of the analysis result, which is obtained when said analyzing section has analyzed the specimen, can be made or not on the basis of the obtained quality control result information, and is adapted to validate the analysis result when the validation of the analysis result has been permitted by the validation permitting section.

18. The analyzing system according to claim 17, further comprising an analysis result validation accepting section for accepting a command of the validation of said analysis result, wherein said specimen validating section is adapted to validate the analysis result when the command of the validation has been accepted by said analysis result validation accepting section and the validation has been permitted by said validation permitting section.

19. The analyzing system according to claim 18, wherein said validation permitting section determines whether the validation of the analysis result can be made or not when the command of the validation has been accepted by said analysis result validation accepting section.

20. The analyzing system according to claim 17, further comprising a message outputting section for outputting a message showing denial of the validation when the validation of the analysis result has been denied by said validation permitting section.
